(19) United States
(12) Patent Application Publication
(10) Pub. No.: US 2008/0082554 A1
(43) Pub. Date: Apr. 3, 2008

(54) Systems and methods for providing a dynamic document index

(76) Inventor: Paul Pedersen, Palo Alto, CA (US)

Correspondence Address: JONES DAY, 222 EAST 41ST ST, NEW YORK, NY, 10017, US

(21) Appl. No.: 11/542,581

(22) Filed: Oct. 3, 2006

(51) Int. Cl. G06F 17/00; G06F 17/30

(52) U.S. Cl. 707/100; 707/3

(57) ABSTRACT

Methods, computers, and computer program products for storing data are provided. A search term is received. A search term lookup identifies a first bucket, and an offset into the first bucket, in a data structure comprising a plurality of buckets. Each bucket is characterized by a different predetermined size. Each bucket comprises a plurality of blocks. Each block in a bucket is allocated the data size in the bucket that characterizes the bucket. A block is retrieved from the first bucket at the offset and modified. The modified block is stored in the first bucket when the modified block does not exceed an allowed size but does exceed a minimum size. The modified block is stored in a second bucket, when the size of the block exceeds the maximum size, and in a third bucket, when the size of the block is less than a minimum size.

### 1. FIELD OF THE INVENTION

The present invention relates generally to information search and retrieval of documents related to a search term. More specifically, a document index is disclosed that facilitates the dynamic store and update of a plurality of data structures, each such data structure representing a set of documents with a given property, such that it is possible for just one data structure in the plurality of data structures to be modified at a given time.

### 2. BACKGROUND OF THE INVENTION

An Internet search engine is one form of information retrieval system. The purpose of an information retrieval system such as an Internet search engine is typically to find those documents in a collection of documents that fulfill certain criteria, called search conditions, such as those documents which contain certain words. In many cases, the “relevance” of documents fulfilling the given search conditions has to be calculated as well. Most often, users of an information retrieval system are only interested in seeing the “best” documents that result from a text search query.

In an information retrieval system, a collection of documents are preprocessed (inverted) to create an inverted index that records, for each index term, its postings in the collection of documents. A posting includes an index term and a document identifier. The document identifier uniquely identifies a given document in a data store. Document indexes have great utility. For example, search engines query a document index using similarity-based search algorithms in order to compute the relevance scores of documents that have index terms in common with the query. An example of such an algorithm is found in Li, IEEE Internet Computing, July•August 1998, pp. 24-29, which is hereby incorporated by reference herein in its entirety.

Typically, to generate inverted indexes for a collection of documents, all documents in the collection are analyzed to identify each occurrence of each index term in a set of index terms together with their positions in the documents. In an “inversion step” this information is sorted so that the index terms become the first order criteria. The result is stored in an inverted index (full posting index) comprising the set of index terms and a full posting list for each index term in the set of index terms. Typically, the posting list of an index term enumerates all occurrences of the index term in all documents in the collection of documents. However, in some cases, a posting list may simply just identify which documents of the collection of documents have the index term anywhere in the document.

An example of a collection of documents and a corresponding full posting index is illustrated in FIG. 8. The collection of documents 800 comprises three text documents: doc1, doc2 and doc3. For simplicity, FIG. 8 does not show the full text of each document but only sequences of index terms a, b, c, and d representing the occurrences of the index terms a, b, c, and d in the full text of the corresponding document. The index terms a, b, c, and d form the set of index terms which inverted index 900 is based upon. It comprises a full posting list for each index term a, b, c, and d, enumerating all occurrences of the corresponding index term in all documents of the collection (doc1, doc2 and doc3). In the example, the occurrences of an index term are grouped by document. Typically, the posting lists are coded and compressed for storage.

Inverted index 900 can be used to process a query, for example, the query “find all documents containing the phrase ‘a b’.” In response to the query, the information retrieval system looks up all positions for “a” and all positions for “b”. Then, the conditions whether “a” and “b” occur in the same document and whether “b” occurs in the position immediately after “a” are checked.

One issue associated with inverted indexes is that they tend to become very large because the size of document collections to be searched is constantly increasing. For instance, a document collection for a search engine can include billions of documents. Even by applying appropriate compression techniques, an inverted index can approach 50 to 100 percent of the size of the original text document collection that has been indexed. To address this problem, additional access structures to posting lists of index terms in an inverted index have been devised. Such additional access structures allow relevant parts of long posting lists to be quickly addressed. In such architectures, the posting lists in an inverted index are no longer considered pure sequential data streams, but rather a sequence of indexed data structure components. Thus, the irrelevant parts of a posting list can easily be skipped by addressing only those data structure components comprising the relevant parts of the posting list. See, for example, United States Patent Publication No. 2005/0144160 A1, which is hereby incorporated by reference herein in its entirety.

Because of their large size, inverted indices are typically too large to fit in RAM (main) memory. This is particularly the case for inverted indices used by Internet search engines that track information about a vast number of documents available on the Internet. Therefore, inverted indices are typically represented as a data structure in secondary (magnetic) storage. A simple method for storing an inverted index is to store a table of records consisting of index terms and a posting for the index terms in a database. This method, however, is known to have low query performance and to require excessive storage space due to redundancy of keywords.

Studies have been done on a method of using tree structures instead of database tables for storing inverted indexes. FIG. 9 shows such a conventional inverted index storage structure. The reference numeral 1000 shows a B+-tree having the index terms as the key. A pointer to a posting list is stored at the pointer field of the index entry in the leaf node of the tree. The reference numeral 1100 shows the storage space for each respective posting list.

Conventional storage structures for inverted indices, while functional, are unsatisfactory because there are no efficient mechanisms for dynamically storing or updating a single posting list within the inverted index without affecting other posting lists or other data structures with the index. Given the above background, what is needed in the art are improved information retrieval systems that allow for dynamic updates of a document index such that even a single posting list within the inverted index can be efficiently updated.

### 3. SUMMARY OF THE INVENTION

One aspect of the present invention provides a computer program product for use in conjunction with a server computer system. The computer program product comprises a computer readable storage medium and a computer program mechanism embedded therein. The computer program mechanism comprises instructions for receiving a query for a search term. A lookup for the search term is then performed. The lookup identifies a first bucket in a data structure comprising a plurality of buckets. The lookup further identifies an offset into the first bucket. Each respective bucket in the plurality of buckets is characterized by a different predetermined data size. Further, each respective bucket in the plurality of buckets comprises a plurality of blocks. Each block in a bucket is allocated the data size that characterizes the bucket. For example, if a bucket is characterized by a data size of 2⁴ bytes, each block in the bucket is allocated 2⁴ bytes of space within the bucket.

The computer program product further comprises instructions for retrieving a block from the first bucket at the offset determined by the lookup. The block is then modified. Once modified, the block is restored to data structure. Specifically, the block, in modified form, is restored to the first bucket at the original offset where the unmodified block was stored when (i) the size of the block does not exceed a maximum allowed block size for the first bucket and (ii) the block, in modified form, exceeds a minimum allowed block size for the first bucket (e.g., in place storage). Alternatively, the block, in modified form, is added to a second bucket in the plurality of buckets when the size of the block, in modified form, exceeds a maximum allowed block size for the first bucket (e.g., overflow storage). Alternatively still, the block is added, in modified form, to a third bucket in the plurality of buckets when the size of the block, in modified form, is less than a minimum allowed block size for the first bucket (e.g., underflow storage).

To illustrate, consider the case in which the first bucket is characterized by a size of 2⁶ or 64 bytes. Thus, each block in the first bucket is allocated 64 bytes, whether such blocks need this much space or not. Say that the retrieved block uses 48 bytes before modification but uses 52 bytes after modification. In this instance, the size of the block does not exceed the maximum allowed block size for the first bucket (2⁶ bytes or 64 bytes) and the block exceeds a minimum allowed block size for the first bucket (say 2⁵ bytes or 32 bytes). Therefore, the block is returned to the first bucket at the same offset where it initially resided. Consider, alternatively, that the retrieved block uses 66 bytes after modification. In this instance, the block, in modified form, exceeds a maximum allowed block size for the first bucket (e.g. 2⁶ or 64 bytes). Therefore, the block, in modified form, is added to a second bucket in the plurality of buckets that is characterized by a larger data size than the first bucket (e.g. 2⁷ bytes or 128 bytes). Consider, alternatively still, that the retrieved block, in modified form, has a size of only 30 bytes. In this instance, the block, in modified form, is less than the minimum allowed block size for the first bucket (e.g., 33 bytes). Therefore, the block is added to a third bucket in the plurality of buckets that is characterized by a smaller data size than the first bucket (e.g. 2⁵ or 32 bytes).

In some embodiments, a first bucket in the plurality of buckets is characterized by a data size of 2⁴ bytes, a second bucket in the plurality of buckets is characterized by a data size of 2⁵ bytes, a third bucket in the plurality of buckets is characterized by a data size of 2⁶ bytes, and a fourth bucket in the plurality of buckets is characterized by a data size of 2⁷ bytes. In some embodiments, the largest buckets in the plurality of buckets are characterized by a data size of 2²⁸ bytes, 2²⁹ bytes, 2³⁰ bytes, or an even larger value. One limitation on the absolute characteristic size of the buckets is that at least some of the blocks in a bucket are stored in RAM memory. Thus, as computers advance and RAM memory sizes increase, the characteristic data size of the largest buckets in the plurality of buckets will increase without departing from the scope of the present invention.

In some embodiments, performing the lookup for the search term comprises hashing the search term to obtain a hash value and retrieving a referencing data structure from a hash table using the hash value. In such embodiments, the referencing data structure comprises the offset and a bucket identifier. In some embodiments, the referencing data structure has a predetermined size and a designated (predetermined) first portion of the referencing data structure is for the offset and a designated (predetermined) second portion of the referencing data structure is for the bucket identifier. In one such example, the referencing data structure has a predetermined size of 64 bits, 59 of which are reserved for the offset and 5 of which are reserved for the bucket identifier. In this example, the referencing data structure can address any of 2⁵⁹ different offsets and could contain 2⁵ different buckets. In other embodiments, there is a trade off between the number of bits reserved for the offset and the number of bits reserved for the bucket identifier. For example, in some embodiments, more bits are reserved for the bucket identifier and fewer bits are reserved for the offset. There is no limitation on the size of the referencing data structure stored by the hash table. For example, the referencing data structure can have a predetermined size between 10 bits or 1000 bits. Larger and smaller data size referencing data structures are possible as well.

In some embodiments there is a minimum block size of 2⁴ (16 bytes) in the data structure. Thus, in some embodiments, blocks having size 2⁴ are designated 2⁰, blocks having size 2⁵ are referred to as 2¹, and so forth such that blocks having size 2ⁿ are referred to as 2ⁿ⁻⁴. Thus, in such embodiments, the entire register is shifted over by four. In some embodiments there is a minimum block size of 2³ (8 bytes) in the data structure. Thus, in some embodiments, blocks having size 2³ are designated 2⁰, blocks having size 2⁴ are referred to as 2¹, and so forth such that blocks having size 2ⁿ are referred to as 2ⁿ⁻³. Thus, in such embodiments, the entire register is shifted over by three.

In preferred embodiments, the present invention provides methods for allocating a portion of each bucket in the plurality of buckets to storage in RAM memory and a portion of each bucket in the plurality of buckets to storage in magnetic memory. Thus, for example, consider the case in which a bucket comprises one hundred blocks. Some of these blocks will be stored in RAM memory and some of these blocks will be stored in magnetic memory (e.g., a hard disk). In some embodiments, a block in the bucket is allocated to the portion of the bucket stored in magnetic memory on a least used basis. For example, consider the case where a given block is the least recently used (LRU) block of all the blocks in the bucket. In this instance, the given block will be stored in the portion of the bucket that is stored in magnetic memory. When the given block is retrieved, and optionally modified, it will be placed in the portion of the bucket that is stored in RAM memory for a period of time until a sufficient number of other blocks in the bucket are accessed to relegate the given block to magnetic memory once again with a least used status.

In some embodiments, a block of the present invention is for a particular index term and comprises an end offset and a plurality of document postings (a document posting list). In some embodiments, each document posting in the plurality of document postings comprises (i) a document identifier uniquely identifying a document that contains the index term; and (ii) a number of occurrences of the index term in the document. For example, consider the case in which a block is for the index term “dog.” Then, the block will include a plurality of document postings for documents that contain the word dog. For each instance of the term “dog” in a given document identified by the block, there will be a document identifier that identifies the given document and the number of times the term “dog” appears in the given document. In some embodiments, the instructions for modifying the block described above comprise instructions for adding one or more document postings to the document posting list in the block. In some embodiments, the instructions for modifying the block comprise instructions for removing one or more document postings from the document posting list in the block. In some embodiments, each document posting in the document posting list of a given block further comprises, for each instance of the index term in the document, (i) a position of the instance of the search term in the document and (ii) a context of the instance of the index term in the document. An example of a context of an instance of an index term is an HTML tag that encloses the instance of the index term in the document.

In preferred embodiments, the present invention further comprises instructions for maintaining a separate free list for each bucket. A free list for a bucket comprises a list of each offset in the bucket that is available. Consider the case where a block is retrieved from a first bucket, modified to the point where it is too large for the first bucket and is therefore added to a second bucket that is characterized by a larger data size. In such embodiments, the offset of the original block in the first bucket is added to the free list for the first bucket. Furthermore, the new offset to the block in the second bucket is removed from the free list for the second bucket. Consider further the case where a block is retrieved from a first bucket, modified to the point where it is too small for the first bucket and is therefore added to a third bucket that is characterized by a smaller data size than the first bucket. In such embodiments, the offset of the original block in the first bucket is added to the free list for the first bucket and the new offset to the block in the third bucket is removed from the free list for the third bucket.

In some embodiments, an index term is a word that appears in one or more documents referenced by the block. In some embodiments, an index term is a name of a vertical collection stored in the block. When a search query is received, the search terms of the query are used to find matching index terms in a dynamic document index. Thus, for purposes of the present invention, the phrases “search term” and “index term” can be used interchangeably.

Still another aspect of the present invention provides a computer program product for use in conjunction with a server computer system. The computer program product comprises a computer readable storage medium and a computer program mechanism embedded therein. The computer program mechanism comprises instructions for receiving a block for storage in a variable size data structure comprising a plurality of buckets. Each respective bucket in the plurality of buckets is characterized by a different predetermined data size. Each respective bucket in the plurality of buckets comprises a plurality of blocks. Each block in a bucket is allocated the data size in the bucket that characterizes the bucket. The computer program mechanism further comprises instructions for determining a size of the block. The size of the block determines an identity of a first bucket in the plurality of buckets that will be used to store the block. The computer program mechanism further comprises instructions for retrieving an offset from a free list that uniquely corresponds to the first bucket, thereby removing the offset from the free list. The computer program mechanism further comprises instructions for storing the block in the first bucket at the offset retrieved from the free list. In some embodiments, the computer program mechanism further comprises instructions for adding a data entry for the block to a lookup table. The data entry comprises the offset and an identifier for the first bucket. In some embodiments, the block represents a search term and the instructions for adding the data entry for the block to the lookup table comprises hashing the search term. In some embodiments, the block represents a vertical collection and the instructions for adding the data entry for the block to the lookup table comprises hashing a name of the vertical collection.

Additional embodiments of the present invention comprise computers and methods that implement the foregoing embodiments.

### 4. BRIEF DESCRIPTION OF THE DRAWINGS

FIG. 1 illustrates a computer system in accordance with an embodiment of the present invention.

FIG. 2 illustrates a variable sized data structure (dynamic document index) that includes a plurality of buckets, each bucket comprising a plurality of blocks and each bucket in the plurality of buckets being characterized by a different predetermined data size.

FIG. 3A illustrates a single bucket from the plurality of buckets of FIG. 2, the single bucket comprising a plurality of blocks in accordance with an embodiment of the present invention.

FIG. 3B illustrates a block, including an end offset and a plurality of document postings, which is stored in the bucket illustrated in FIG. 3A.

FIG. 3C illustrates the details of a document posting in the block illustrated in FIG. 3B.

FIG. 4A illustrates a typical HTML document in accordance with the prior art in which the search term “boat” is located at four different instances within the document.

FIG. 4B illustrates the details of a document posting for the document illustrated in FIG. 4A that is stored in a block in accordance with embodiments of the present invention.

FIG. 5 illustrates a hash table for storing locations of blocks within a dynamic document index in accordance with an embodiment of the present invention.

FIG. 6 illustrates a quality score index for storing a quality statistics for documents in a document collection in accordance with an embodiment of the present invention.

FIG. 7 illustrates a plurality of free block lists for buckets in accordance with the present invention.

FIG. 8 illustrates a collection of documents and a corresponding full posting index in accordance with the prior art.

FIG. 9 illustrates an inverted index storage structure in accordance with the prior art.

Like reference numerals refer to corresponding parts throughout the several views of the drawings.

### 5. DETAILED DESCRIPTION

The present invention provides an improvement to the class of data structures that serves as indexes of a collection of documents keyed on index terms. One example of such a data structure is an inverted index that stores, for each respective index term in a plurality of index terms, a document posting list referencing documents in a document collection that contain the index term. Using the methods of the present invention, an individual document posting list can be efficiently modified without affecting other document posting lists in the inverted index.

In additional to traditional document postings of index terms, the data structures of the present invention can store vertical collections. Such vertical collections are treated in the same manner as document posting lists in the present invention. A “vertical collection” comprises a set of documents (e.g., URLs, websites, etc.) that relate to a common category. For example, web pages pertaining to sailboats could constitute a “sailboat” vertical collection. Web pages pertaining to car racing could constitute a “car racing” collection. However, there is no requirement that the documents in the “car racing” vertical collection have the index terms “car” or “racing”. Users search a vertical collection so that only documents relevant to the category represented by the vertical collection are returned to the user.

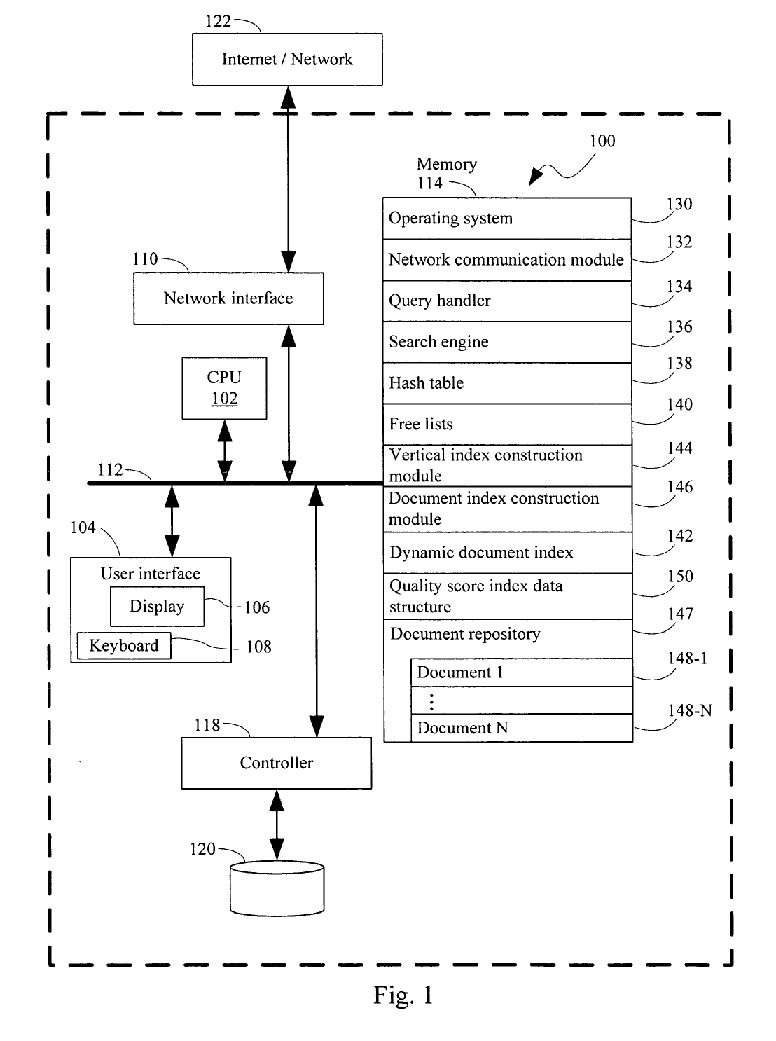

FIG. 1 illustrates a server 100 in accordance with one embodiment of the present invention. In some embodiments, server 100 is implemented using one or more computer systems. It will be appreciated by those of skill in the art, that servers designed to process large volumes of information retrieval queries may use more complicated computer architectures than the one shown in FIG. 1. For instance, a front end set of servers may be used to receive and distribute search queries among a set of back-end servers that actually process the user queries. In such a system, server 100 as shown in FIG. 1 would be one such back-end server.

Server 100 will typically have a user interface 104 (including a display 106 and a keyboard 108), one or more processing units (CPUs) 102, a network or other communications interface 110 for connecting to the Internet and/or other form of network 122, memory 114, and one or more communication busses 112 for interconnecting these components. Memory 114 can include high speed random access memory (ram) and can also include non-volatile memory, such as one or more magnetic disk storage devices 120 controlled by one or more controllers 118. Disk storage devices can be remotely located.

Memory 114 preferably stores:

an operating system 130 that includes procedures for handling various basic system services and for performing hardware dependent tasks;

a network communication module 132 that is used for connecting server 100 to various client computers (not shown) and possibly to other servers or computers via one or more communication networks 122 such as the Internet, other wide area networks, local area networks (e.g., a local wireless network can connect client computers to server 100), metropolitan area networks, and so on;

a query handler 134 for receiving search queries from a client computer;

a search engine 126 for searching a dynamic document index 142 for documents 148 in document repository 147 related to a search query and for forming a group of ranked documents that are related to the search query;

a hash table 138 for tracking the location of posting lists for index terms as well as vertical collections in dynamic document index 142;

a collection of free lists 140 for tracking availability of space in dynamic document index 142;

dynamic document index 142 for storing posting lists for index terms and/or vertical collections;

an optional vertical index construction module 144 for constructing one or more vertical collections;

a document index construction module 146 for constructing dynamic document index 142 from a set of documents 148 in document repository 147; and

an optional quality score index data structure 150 for tracking the quality score index of various documents 148 in document repository 147 for particular index terms.

The methods of the present invention begin before a search query is received by query handler 134 with document index construction module 146. Document index construction module 146 constructs a document index by scanning documents 148 in document repository 147 for relevant index terms. An illustration of the document index is illustrated below:

| Index term | Document identifier list |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, the document index is constructed by document index construction module 146 by conventional indexing techniques. Exemplary indexing techniques are disclosed in United States Patent publication 2006/0031195, which is hereby incorporated by reference herein in its entirety. By way of illustration, in some embodiments, a given index term may be associated with a particular document when the index term appears more than a threshold number of times in the document. In some embodiments, a given index term may be associated with a particular document when the index term achieves more than a threshold score. Criteria that can be used to score a document relative to a candidate index term include, but are not limited to, (i) a number of times the index term appears in an upper portion of the document, (ii) a normalized average position of the index term within the document, (iii) a number of characters in the index term, and/or (iv) a number of times the document is referenced by other documents. High scoring documents are associated with the index term.

Typically, when a document is associated with an index term, the document is added to a posting list for the index term. In some embodiments, the document index stores the list of index terms and a posting list for each respective index term uniquely identifying the documents in a collection of documents that contain the respective index term. In some embodiments, the document index stores a collection of index terms, the identities of documents in a collection of document that contain such index terms, and the relevance or other form of quality scores of these documents. Those of skill in the art will appreciate that there are numerous methods for associating index terms with documents in order to build a document index and all such methods can be used to construct document indexes used in the present invention.

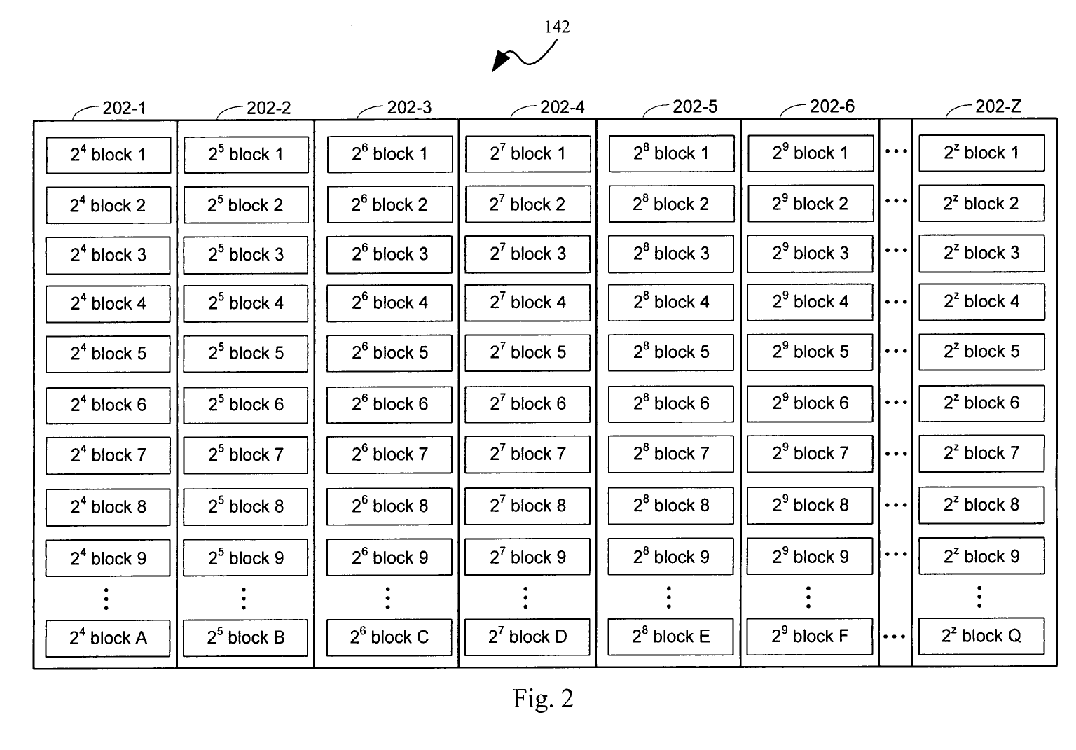

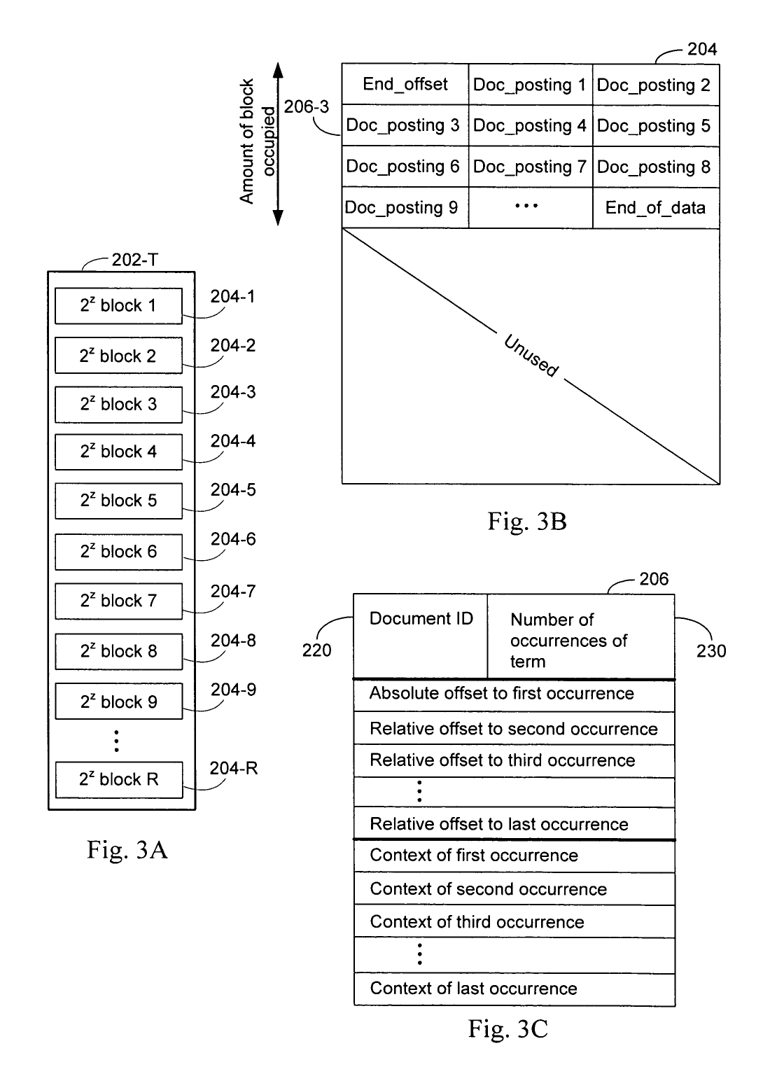

Advantageously, the document index constructed by document index construction module 144 is stored in a dynamic document index 142. FIG. 2 illustrates a dynamic document index 142 in accordance with the present invention. Dynamic document index 142 comprises a plurality of buckets 202. Referring to FIGS. 2 and 3A, each bucket 202 comprises a plurality of blocks 204. There is no requirement that each bucket 202 in dynamic document index 142 contain the same number of blocks 204. Each respective bucket 202 in dynamic document index 142 is characterized by a different predetermined data size. Further, in the present invention, each block 204 in a respective bucket 202 in dynamic document index 142 is allocated the data size in the respective bucket 202 that characterizes the respective bucket. For example, if the respective bucket 202 is characterized by a data size of 2⁴ bytes, in preferred embodiments, each block 204 in the bucket is allocated 2⁴ bytes whether the blocks presently need this much space or not.

In populating dynamic document index 142, reconsider the document index:

| Index term | Document identifier list |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In preferred embodiments, the document identifier list (or posting list) for each index term will occupy a different block 204 in dynamic document index 142. The size of a respective document identifier list (posting list) in the illustrated document index will dictate which bucket 202 the block 204 containing the respective posting list will be stored. For example, consider the dynamic document index 142 illustrated in FIG. 2 which has a bucket characterized by a data size of 2⁴ (202-1), 2⁵ (202-2), 2⁶ (202-3), 2⁷ (202-4), 2⁸ (202-5), 2⁹ (202-6), . . . , 2^{Z} (202-Z). Now consider a block 204 for storage term 1, together with the document identifier list for term 1, of the above-illustrated conventional document index. Say that the amount of block 204 that is occupied is 10 bytes (see, e.g., FIG. 3B). In this case, block 204 will be stored in bucket 202-1. Alternatively, consider the case in which the amount of the block that is occupied is 100 bytes. The block will no longer fit in bucket 202-1 because the data size allocated for a block 204 in bucket 202-1 is 2⁴ or 16 bytes. Nor can the block be stored in bucket 202-2 or 202-3 since the data size allocated for a block in these buckets is 2⁵ (32) bytes and 2⁶ (64) bytes, respectively. Thus, block 204, which contains 100 bytes, will be stored in bucket 202-4 since this bucket has allocated 2⁷ (128) bytes per block.

In general, a block 204 is stored in the bucket 202 that has the smallest characteristic size that will still accommodate the blocks. There are a number of sorting methods for identifying the suitable bucket 202 for storage of a given block 204 based on the data size of the block and all such methods are within the scope of the present invention. A method of examining the bucket 202 having the smallest characteristic data size and then examining buckets 202 characterized by sequentially larger data sizes has been outlined in the example above. Alternatively, one could start with the bucket 202 characterized by the largest data size and examine buckets 202 with sequentially smaller data sizes. In general, to store a block 204 in a given bucket 202, the size of the block 204 cannot exceed a maximum allowed block size for the given bucket (which in preferred embodiments is, in fact, the data size that characterizes the given bucket) but must exceed a minimum allowed block size for the given bucket. In preferred embodiments, the minimum allowed block size of a given bucket is determined by the characteristic data size of the bucket 202 that is sequentially smaller than the characteristic data size of the given bucket. Thus referring to FIG. 2, for example, the minimum allowed block size for bucket 202-2 is 2⁴ bytes+1 bit and the maximum allowed block size is 2⁵ bytes, the minimum allowed block size for bucket 202-3 is 2⁵ bytes+1 bit and the maximum allowed block size is 2⁶ bytes, the minimum allowed block size for bucket 202-4 is 2⁶ bytes+1 bit and the maximum allowed block size is 2⁷ bytes, the minimum allowed block size for bucket 202-5 is 2⁷ bytes+1 bit and the maximum allowed block size is 2⁸ bytes, and so forth.

In some embodiments, any word found in any document in a corpus of documents 148 is stored as an index term in a block 204 together with the document posting list for the term. In some embodiments, certain words are excluded from the list of possible index terms stored in dynamic document index 142. For example, common words such as “a”, “the”, “but”, “and”, or “an” are excluded. In another example, an authorized user (e.g., a parent) may exclude certain words that are deemed to be offensive or inappropriate from dynamic document index 142. In some embodiments, any phrase found in any document in a corpus of documents 148 is stored as an index term in a block 204 together with the document posting list for the term.

There is no limit on the number of documents 148 that can be referenced in the posting list for an index term. For example, in some embodiments, between 10,000 and 100,000 documents 148 are referenced the posting list for an index term, between 100,000 and 1×10⁶ documents 148 are referenced in the posting list for an index term, between 1×10⁶ and 1×10⁷ documents 148 are referenced in the posting list for an index term, between 1×10⁷ and 1×10⁸ documents 148 are referenced in the posting list for an index term, or more than 1×10⁸ documents 148 are referenced in the posting list for search term with dynamic document index 142. As used here, the term “referenced” means that the posting list contains sufficient information to uniquely identify the document in a data store. The means used to uniquely identify the document is application specific. If the document is located in RAM memory, the document may by referenced by a pointer. Alternatively, a document may be referenced by a unique document identifier assigned to the document. Furthermore, there is no limit on the number of index terms to which a given document 148 may be associated. For instance, a given document may contain one hundred different index terms. Thus, one hundred different posting lists, one for each of the one hundred index terms, will reference the document. A given document 148 can be associated with between 0 and 100 index terms, between 0 and 1000 index terms, between 100 and 10,000 index terms, between 10,000 and 100,000 index terms, or more than 100,000 index terms in this way.

In the context of this application, documents 148 are understood to be any type of media that can be indexed and retrieved by a search engine, including web documents, images, multimedia files, text documents, PDFs or other image formatted files, ringtones, full track media, and so forth. A document 148 may have one or more pages, partitions, segments or other components, as appropriate to its content and type. Equivalently, a document 148 may be referred to as a “page,” as commonly used to refer to documents on the Internet. In fact, particularly long documents may be logically broken up by document index construction module 146 into separate documents. For example, a 100+ page PDF manual may be logically split into 100+ different documents, where each such document represents a different page of the PDF manual. No limitation as to the scope of the invention is implied by the use of the generic term “documents.”

In the present invention, there are many documents 148 indexed by document index construction module 146. Typically, there are more than one hundred thousand documents, more than one million documents, more than one billion documents, or even more than one trillion documents indexed by document index construction module 146. For the sake of illustration, document index construction module 146 has been construed as first creating a conventional document index and then populating dynamic document index 142. However, document index construction module 146 was presented in this manner solely to assist the reader in understanding how dynamic document indexes 142 of the present invention differ from conventional inverted indexes. In fact, there is no requirement that document index construction module 146 first construct a conventional inverted index prior to populating dynamic document index 142. Document index construction module 146 can construct posting lists for index terms found in a corpus of documents and populate dynamic document index 142 directly based on the size of each posting list constructed.

Advantageously, dynamic document index 142 can store data structures other than posting lists for index terms found in a corpus of documents. Each block 204 in dynamic document index 142 can store any data structure that contains the identity of a collection of documents that share some unique property. The example of a posting list for an index term is one such data structure. Each document referenced in the posting list has the unique property of containing the index term somewhere in the document. Another example of a collection of documents that share some unique property is a vertical collection. A vertical collection is a reference to a collection of documents 148 that have been identified on some basis as sharing some unique property. There is no requirement that this unique property be the presence of an index term within documents. Vertical collections and methods of using such vertical collections are described in more detail in U.S. patent application Ser. No. 11/404,687, filed Apr. 13, 2006, and Ser. No. 11/404,620, filed Apr. 13, 2006, which are each hereby incorporated by reference herein, in their entireties. Vertical index constructions module 144 can use the vertical collections and document posting lists for index terms stored in dynamic document index 142 to construct a vertical index. Other data structures that can be stored in dynamic document index 142 include anchor collections which include, for any given web page, the list of URLs that reference the web page as well as the text around each such reference. For example, consider the case in which there is a first page and a second page that references the first page. The anchor collection will include the identity of the second page as well as the text surrounding the reference in the second page to the first page (e.g., what the second page has to say about the first page). Thus, the anchor text provides, for a given URL, the referencing text of other pages that refer to the URL.

In some embodiments, vertical collections are constructed using documents referenced in an inverted index that pertain to a particular non-hierarchical category. For example, one vertical collection may be constructed from documents referenced in an inverted index that pertains to movies, another vertical collection may be constructed from documents referenced in an inverted index that pertains to sports, and so forth. Vertical collections can be constructed, merged, or split in a relatively straightforward manner. In some embodiments, there are thousands of vertical collections set up in this manner. In some embodiments, there are millions of vertical collections set up in this manner. In preferred embodiments, each such vertical collection is stored in a block 204 of dynamic document index in the same manner that document posting lists for index terms are individually stored in blocks 204.

In some embodiments, a first bucket 202 in dynamic document index 142 is characterized by a data size of 2⁴ bytes, a second bucket 202 in dynamic document index 142 is characterized by a data size of 2⁵ bytes, a third bucket 202 in dynamic document index 142 is characterized by a data size of 2⁶ bytes, and a fourth bucket 202 in dynamic document index 142 is characterized by a data size of 2⁷ bytes, and so forth through a bucket 202 characterized by a data size of 2²⁸ bytes, 2²⁹ bytes, 2³⁰ bytes, or an even larger value. Thus, some embodiments of the present invention provide a dynamic document index 142 containing a buckets characterized by a data size of 2⁴, 2⁵, 2⁶, 2⁷, 2⁸, 2⁹, 2¹⁰, 2¹¹, 2¹², 2¹³, 2¹⁴, 2¹⁵, 2¹⁶, 2¹⁷, 2¹⁸, 2¹⁹, 2²⁰, 2²¹, 2²², 2²³, 2²⁴, 2²⁵, 2²⁶, 2²⁷, 2²⁸, 2²⁹, 2³⁰, or 2³¹ bytes. There is no requirement that the characteristic data size of a bucket be a power of 2. Other characteristic data sizes are possible. One limitation on the absolute size of the buckets is that at least some of the blocks 204 allocated within a bucket are stored in memory 114 (RAM memory). Thus, as computers advance and RAM memory sizes increase, the largest characteristic data size of buckets 202 in dynamic document index 142 will increase without departing from the present invention.

In preferred embodiments, a portion of each bucket 202 in dynamic document index 142 is stored in RAM memory (e.g., memory 114 of FIG. 1) while the remainder is stored in magnetic memory (e.g., memory 120 of FIG. 1). Thus, for example, consider the case in which a bucket 202 comprises one hundred blocks 204. Some of these blocks 204 will be stored in RAM memory 114 and the remainder will be stored in magnetic memory 120 (e.g., a hard disk). A block 204 in a given bucket 202 is allocated to the portion of the bucket stored in magnetic memory on a least used basis. For example, consider the case where a given block 204 is the least recently used block 204 of all the blocks in a given bucket 202. In this instance, the given block 204 will be stored in the portion of the bucket 202 that is stored in magnetic memory 120. When the given block 204 is retrieved and optionally modified, it will be placed in the portion of the bucket 202 that is stored in RAM memory 114 for a period of time until a sufficient number of other blocks 204 in the bucket 202 are accessed to thereby relegate the block a least recently used status that sends the block back to magnetic memory 120.

In some embodiments an entire bucket is stored in RAM memory. In some embodiments the most recently used bucket is stored in RAM memory. However, as is known to those of skill in the art, the operating system of a computer system will frequently page data structures, or portions thereof, in and out of RAM memory. Thus, the number of blocks in any given bucket that is actually stored in RAM memory at any given time may vary over time. In some embodiments, there is a threshold indicator that states that for buckets below the threshold, the entire bucket is to be stored in RAM and for buckets above the threshold, only blocks in the bucket are to be stored in RAM. This threshold may be a block size (e.g., 2²⁰). However, even in such embodiments, operating system paging may cause the amount of the buckets that is stored in RAM memory to vary from this general threshold specification.

In some embodiments, the percentage of blocks relegated to magnetic memory 120 is the same or different for each bucket 202 in dynamic document index 142. In some embodiments, a threshold number of blocks 204 in a given bucket are permitted in RAM memory 114 rather than limiting the number of blocks 204 in RAM memory 114 to a given percentage of the blocks 204 of a bucket 202. For instance, in some embodiments up to 100, up to 1000, up to 10⁴, up to 10⁵, up to 10⁶, up to 10⁷, up to 10⁸, up to 10⁹, up to 10¹⁰ blocks 204 in a given bucket 202 can be stored in RAM memory 114 while the remainder of the blocks in the bucket are stored in magnetic memory 120. In some embodiments, each of the blocks 204 in a given bucket 202 that are stored in magnetic memory 120 have a least used status. In some embodiments of the present invention, the portion of dynamic document index 142 stored in RAM memory 114 uses between 25 percent and 75 percent of all available RAM memory in server 100. In some embodiments, the portions of dynamic document index 142 that are stored in RAM memory 114 are on server 100 but the portions of dynamic document index 142 relegated to magnetic memory may be stored on computers or other devices containing computer readable media that are addressable by server 100 across Internet/network 122.

Referring to FIG. 3A, in some embodiments, a block 204 of the present invention comprises an end_offset (end offset) and a plurality of document postings 206 (posting list). The end offset identifies the end point of the posting list. Thus, in effect, the end offset indicates where additional document postings 206 may be added to the posting list. The end offset is updated each time a document posting 206 is added to or taken from the posting list.

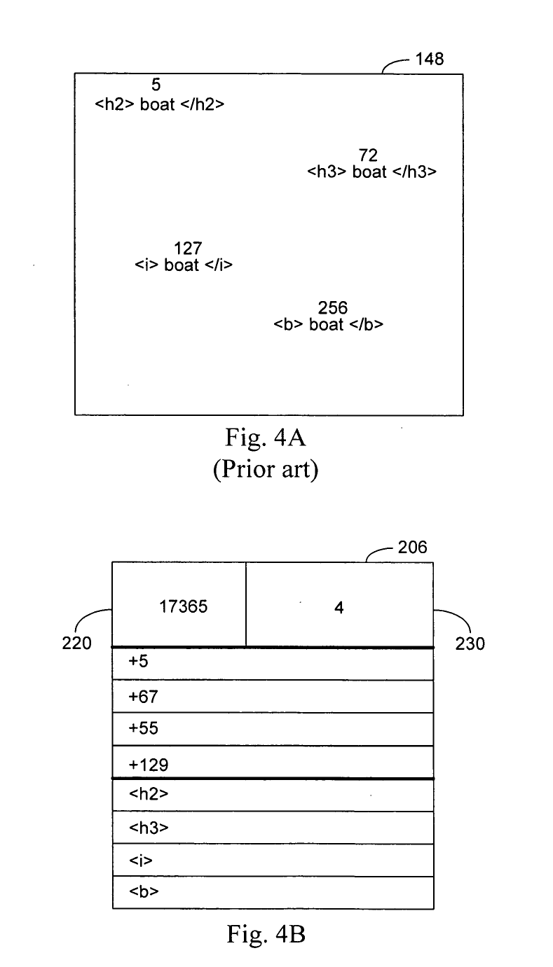

Referring to FIG. 3C, in some embodiments, each document posting 206 in the posting list (plurality of document postings) found in a given block 204 comprises (i) a document identifier 220 uniquely identifying a document 148, and (ii) a number of occurrences 230 of an index term in the referenced document. For example, consider the case in which a block 204 stores the posting list for the index (search) term “dog.” Then, the block 204 will include a plurality of document postings 206 for documents 148 that each contains the word “dog”. In preferred embodiments, each document posting 206 will be for a different document 148. Each such document posting 206 will include a document identifier 220 that identifies a specific document and the number of times 230 the term “dog” appears in the specific document. Continuing to refer to FIG. 3C, for each occurrence of the term in the referenced document, the absolute offset to the occurrence is provided. For example, consider the document 148 illustrated in FIG. 4A that has been indexed for the index term “boat”. The term “boat” is found four times in the document, a first time at offset 5, a second time at offset 72, a third time at offset 127, and a fourth time at offset 256. Thus, in FIG. 4B, an exemplary document posting 206, in accordance with one embodiment of the present invention, is provided for the document 148 illustrated in FIG. 4A. Field 220 of the document posting 206 of FIG. 4B includes the document ID “17365” which uniquely identifies the document 148 of FIG. 4A. Field 230 of the document posting 206 of FIG. 4B has the value “4” which indicates the number of instances of the term “boat” in document 17365. Further, document posting 206 of FIG. 4B lists the offset to the word “boat” from the beginning of the document. In FIG. 4B, the offset to the first instance of the index term is an absolute offset value meaning that it is the offset from the beginning of the referenced document. Each additional offset is a relative offset. For instance the offset provided for the second instance of the term “boat” is 67, because the second instance of “boat” is at 72, which is 67 words away from the beginning of the first instance of the word “boat” at offset 5. Other forms of representing the positions of index terms in a referenced document are possible and all such schemes are within the scope of the present invention. For example, rather than using the offset from the beginning of the file, an offset from the end of the file can be used.

In some embodiments of the present invention, document posting 206 advantageously has additional information. In addition to providing the offset for each instance of a given index term in a referenced document, document posting provides the context of each instance of the search term in the document. An example of a search term context in a referenced document is an identity of an HTML tag that encloses the instance of the search term in the document. FIG. 4 illustrates the point. The context of the first instance of the index term “boat” in the document illustrated in FIG. 4A is the HTML tag “/h2” meaning “header 2” because this is the HTML tag that immediately bounds the first instance of the term “boat.” Consider the case in which an index term is bounded by more than one set of HTML tags (e.g. “<b><h2> boat </h2></b>”). In such cases, the tag that most immediately bounds the instance of the index term is the context of the instance of the index term (e.g., for “<b><h2> boat </h2></b>”, the context is <h2>). In some embodiments, certain tags are ignored. For example, in some embodiments the italics HTML tag is ignored even if it immediately bounds the instance of the index term. Thus, in some embodiments, the nearest enclosing not-ignorable enclosing HTML tag is deemed to be the context of the instance of the search term. In some embodiments, multiple levels of context can be stored for a given instance of an index term in a document in the document posting 206 for the document (e.g., for “<b><h2> boat </h2></b>”, the context would be <h2><b>). Here again, certain predesignated HTML terms such as the italics term can be ignored in preferred embodiments. As illustrated in FIG. 4B, in preferred embodiments only a single context level is provided for each instance of the search term “boat” in the document illustrated in FIG. 4A. In preferred embodiments the offset values in document posting 206 are compressed and packed. In preferred embodiments, the context descriptions in the document posting are compressed.

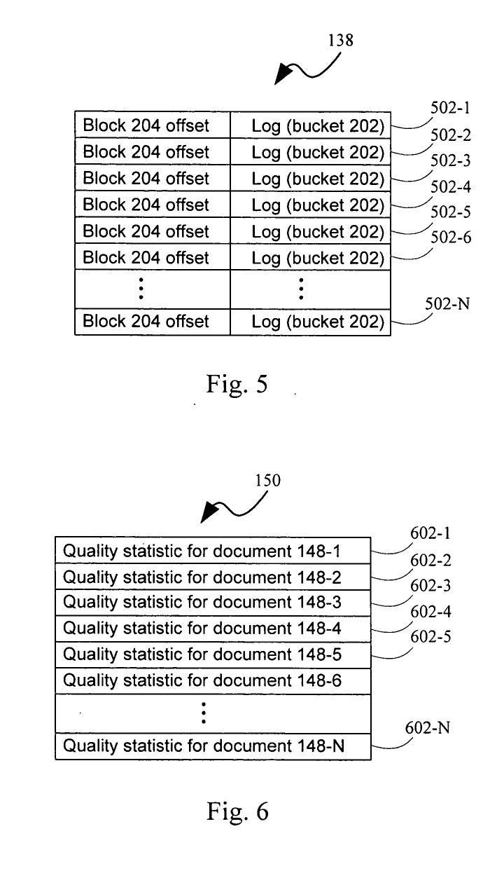

Referring to FIG. 5, a description of a hash table 138 in accordance with the present invention is provided. Hash table 138 tracks the location of each block 204 in dynamic document index 142. Thus, in some embodiments of the present invention, performing a lookup for an index (search) term comprises hashing the index (search) term to obtain a hash value and retrieving a data structure 502 from hash table 138 using the hash value. In some embodiments, data structure 502 comprises a block 204 offset and a bucket identifier. In some embodiments, data structure 502 stores the logarithm of the bucket to save space. In some embodiments, data structure 502 has a predetermined size and a predetermined first portion of the data structure is for the offset (block 204 offset) and a predetermined second portion of the data structure is reserved for the bucket identifier. In one such example, data structure 502 has a predetermined size of 64 bits, 59 of which are reserved for the offset (block 204 offset) and 5 of which are reserved for the bucket identifier. Thus, in this example, data structure 502 of hash table 138 can address any of 2⁵⁹ different offsets.

There is no limitation on the size of the data structure 502 referenced by the hash table. For example, each data structure 502 can have a predetermined size between 10 bits or 1000 bits. Larger and smaller data sizes are possible as well.

In FIG. 5, each data structure 502 references a particular block 204 in document index 142. Each block 204 contains information about a collection of documents that share a property. Advantageously, an information retrieval system such as query handler 134/search engine 136 does not need to know the bucket or the offset to a given block in dynamic document index 142 in order to retrieve any block in dynamic document index 142. In some embodiments, all that needs to be done to retrieve a block 204 from dynamic document index 142 is to hash the index term of interest or the vertical collection of interest and then retrieve the data structure 502 associated with the resulting hash value from hash table 138. Thus, to obtain a block that contains the posting list for the term “boat” from dynamic document index 142, the term “boat” is hashed to obtain a hash value, and the data structure 502 in hash table 138 having this hash value is retrieved. In exemplary embodiments, to obtain the data structure 502 that stores the location of a vertical collection entitled “boats” that is stored in a block 504 in dynamic document index 142, the expression hash(vert:boats) is evaluated to obtain a hash value. Then the data structure 502 in hash table 138 having this hash value is retrieved. Thus, by using logical hash expressions such as hash(index term:boat) versus hash(vert:boat), blocks that store posting lists for indexed terms as well as vertical collections can be stored in the same dynamic document index 142 by making use of hash table 138. In some embodiments, dynamic document index 142 only stores posting lists for indexed terms and does not store vertical collections. In some embodiments, dynamic document index 142 only stores vertical collections and does not store posting lists for indexed terms. In some embodiments, other data constructs other than a hash table are used to store data structures 502. For instance, the location of each block 204 in dynamic document index 142 can be stored in a flat file, a database, a linked list, or any other computer readable data structure rather than hash table 138. However, in preferred embodiments, hash table 138 is used because it has low overhead both in terms of memory usage and computational requirements.

Referring to FIG. 6, in some embodiments, a quality statistic 602 for each document relative to a given index term is stored in quality score index data structure 150. There is a broad range of quality statistics that may be stored for a given document in data structure 602. For example, a score for the given document may be stored in data structure 602 that is computed based on criteria such as (i) the number of other URLs that reference the given document, (ii) the size of the document, and/or (iii) the date the document was posted on the Internet. Such a quality score would be index term independent and therefore would be an applicable quality score regardless of the search terms of a given information retrieval query. Alternatively or additionally, scores based on the number of times a given index term is found in the document or the context of the index term in the document may be stored in data structure 602. In such embodiments, consultation of quality score index data structure would require both the document identifier for the document for which a quality score is desired and one or more index terms of interest. For example, quality score index data structure 150 may be consulted for a quality score for document number 103393 given the index term “boat” in order to one quality statistic 602 for document 103393. Then, quality score index data structure 150 may be consulted for a quality score for document number 103393 given the index term “car” in order to another quality statistic 602 for document 103393.

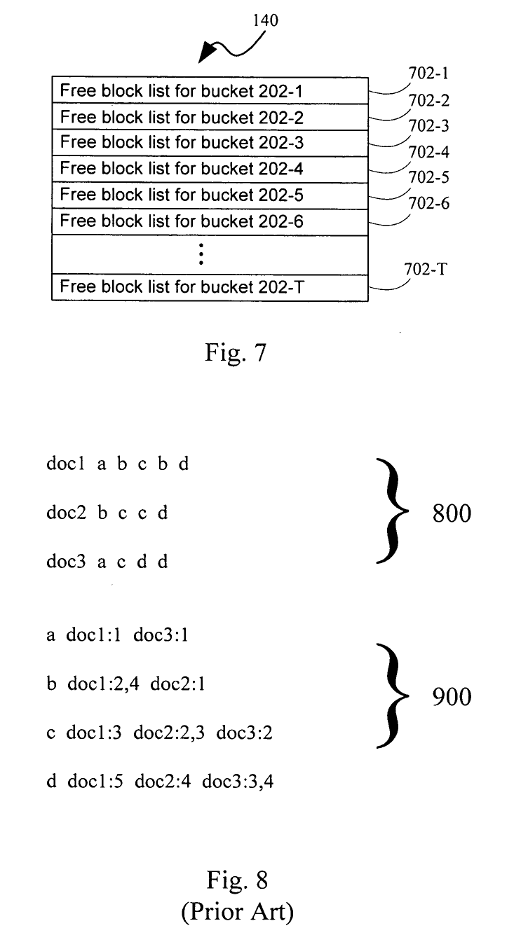

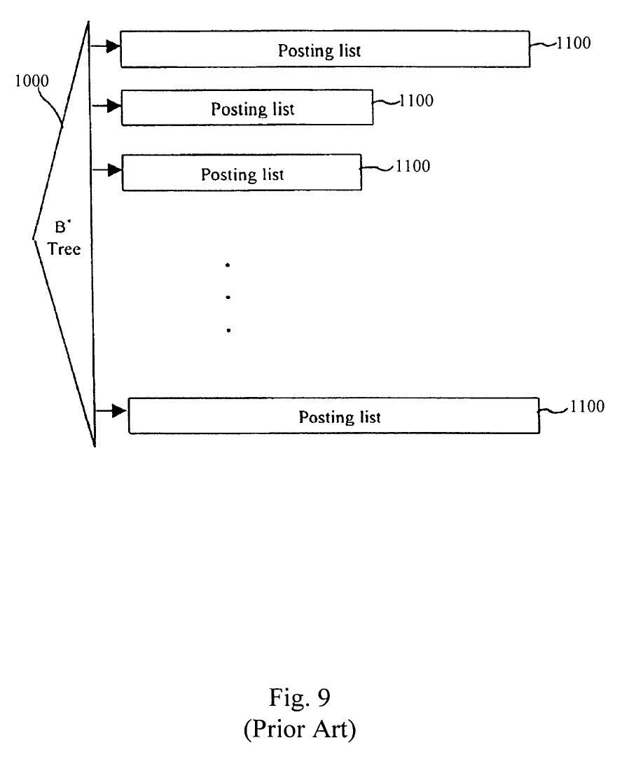

Referring to FIG. 7, the usage of free lists 140, and a data structure such as hash table 138, combined with the fixed amount of space allocated to each block 204 in dynamic document index 142, allows for the ability to modify, delete, or add individual blocks 204 to dynamic data document index 142 in a single instance without having to re-sort blocks in dynamic document index 142 that have not been modified, added or deleted. Each free list 702 keeps track of each of the offsets that are not currently being used by a block in a particular corresponding bucket 202. In preferred embodiments, and as illustrated in FIG. 7 in conjunction with FIG. 2, there is a one-to-one correspondence between a free list 702 in free lists 140 and a bucket 202 in dynamic document index 142. Therefore, when a determination has been made that a new block 204 is to be added to a bucket 202, the free list 702 for the bucket 202 is consulted for a free offset in the bucket. The new block 204 is added at the offset and the offset is removed from the free list for the bucket. When a determination is made to remove a block 204 from a bucket 202, the offset for the block into the bucket is simply added to the free list 702 for the bucket. At some later point in time, this offset will be used to add a new block 204 to the bucket and the block at that offset slated for deletion will be overwritten.

Methods for using the software modules and data structures of the present invention to modify a given block 204 without having to operate, shuffle or otherwise disturb any other blocks in dynamic document index 142 will now be described. In some embodiments, search engine 136 receives a query request that includes search terms. A lookup for a search term in the query request is then performed by query handler 134 using hash table 138 thereby identifying a data structure 502. Data structure 502 identifies a first bucket 202 in dynamic document index 142. Data structure 502 further identifies an offset into the first bucket. The block 204 identified by data structure 502 is retrieved from the identified bucket 202 at the offset specified by data structure 502. The block 204 is then modified. Once modified, the block 204 is restored to dynamic document index 142. Specifically, the block, in modified form, is restored to the original bucket at the original offset specified by data structure 502 when (i) the size of the block, in modified form, does not exceed a maximum allowed block size for the original bucket 202 and (ii) the block, in modified form, exceeds a minimum allowed block size for the original bucket. In typical embodiments, the maximum allowed block size is the characteristic size of the original bucket (e.g., 2⁸ bytes). If the modified block no longer satisfies these criteria, the block is simply added to another bucket. For instance, in some embodiments, the block, in modified form, is added to one bucket in the dynamic document index 142 when the size of the block, in modified form, exceeds a maximum allowed block size for the original bucket and to another bucket in the dynamic document index 142 when the size of the block, in modified form, is less than a minimum allowed block size for the original bucket. To illustrate, consider the case in which the original bucket is characterized by a size of 2⁶ or 64 bytes. Thus, each block 204 in original bucket 202 is allocated 64 bytes, whether the blocks use this much space or not. Say that the retrieved block uses 48 bytes before modification but uses 52 bytes after modification. In this instance, the size of the block does not exceed the maximum allowed block size for the first bucket (2⁶ bytes or 64 bytes) and the block exceeds a minimum allowed block size for the original bucket (say 2⁵ bytes or 32 bytes). In this instance, the block 204, in modified form, is returned to the original bucket 202 at the same offset where it initially resided. Consider, alternatively, that the retrieved block 204 uses 66 bytes after modification. In this instance the block, in modified form, exceeds a maximum allowed block size for the original bucket 202 (e.g. 2⁶ or 64 bytes). Therefore the block, in modified form, is added to another bucket 202 in dynamic document index 142 that is characterized by a larger data size than the first bucket (e.g. 2⁷ bytes or 128 bytes). Consider alternatively still, that the retrieved block, in modified form, has a size of only 30 bytes. In this instance the block, in modified form, is less than the minimum allowed block size for the original bucket 202 (e.g., 33 bytes). Therefore the block 204 is added, in modified form, to a bucket in dynamic document index 142 that is characterized by a smaller data size than the original bucket (e.g. 2⁵ or 32 bytes). Free lists 140 are updated appropriately to reflect the location of the block 204. For instance, if block 204 is returned to the original offset of the original block 202, no free list 702 is updated. If the block is added to a new offset in a new bucket 202, the offset in the new bucket 702 is removed from the free list for the new bucket 702 and the original offset in the original bucket 202 is added to the free list 702 for the original bucket.

In some embodiments, a block 204 comprises a plurality of document postings and the above-referenced modifications that are made to a block 204 include adding one or more document postings to the plurality of document postings in the block. In some embodiments, the above-referenced modifications that are made to a block comprise removing one or more document postings from the plurality of document postings in the block.

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1 or the data structures shown in any one or more of FIGS. 1, 2, 3, 4, 5, 6, or 7. These program modules can be stored on a CD-ROM, DVD, magnetic disk storage product, or any other computer readable data or program storage product. The software modules in the computer program product may also be distributed electronically, via the Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A computer program product for use in conjunction with a computer system, wherein the computer program product comprises a computer readable storage medium and a computer program mechanism embedded therein, the computer program mechanism comprising instructions for:
receiving a query for a search term;
performing a lookup for said search term, wherein said lookup identifies a first bucket in a data structure comprising a plurality of buckets, the lookup further identifying an offset into said first bucket, wherein each respective bucket in said plurality of buckets is characterized by a different predetermined data size, and wherein each respective bucket in said plurality of buckets comprises a plurality of blocks, and wherein each block in the plurality of blocks in a respective bucket in said plurality of buckets is allocated the data size in the respective bucket that characterizes the respective bucket;
retrieving a block from the first bucket at the offset determined in said performing step;
modifying said block;
restoring said block, in modified form, to said first bucket at said offset when a size of said block does not exceed a maximum allowed block size for said first bucket and said block, in modified form, exceeds a minimum allowed block size for said first bucket;
adding said block, in modified form, to a second bucket in said plurality of buckets when the size of said block, in modified form, exceeds a maximum allowed block size for said first bucket; and
adding said block, in modified form, to a third bucket in said plurality of buckets when the size of said block, in modified form, is less than a minimum allowed block size for said first bucket.

2. The computer program product of claim 1, wherein
a first bucket in said plurality of buckets is characterized by a data size of 2⁴ bytes;
a second bucket in said plurality of buckets is characterized by a data size of 2⁵ bytes;
a third bucket in said plurality of buckets is characterized by a data size of 2⁶ bytes; and
a fourth bucket in said plurality of buckets is characterized by a data size of 2⁷ bytes.

3. The computer program product of claim 1, wherein a bucket in said plurality of buckets is characterized by a data size of 2²⁸ bytes.

4. The computer program product of claim 1, wherein a bucket in said plurality of buckets is characterized by a data size of 2²⁹ bytes.

5. The computer program product of claim 1, wherein a bucket in said plurality of buckets is characterized by a data size of 2³⁰ bytes.

6. The computer program product of claim 1, wherein said performing said lookup for said search term comprises:
hashing said search term to obtain a hash value; and
retrieving a data structure from a hash table using said hash value, wherein said data structure comprises said offset and a bucket identifier.

7. The computer program product of claim 6, wherein said data structure has a predetermined size and a predetermined first portion of said data structure is for said offset and a predetermined second portion of said data structure is for said bucket identifier.

8. The computer program product of claim 7, wherein the predetermined size is between 10 bits or 1000 bits.

9. The computer program product of claim 1, wherein the computer program mechanism further comprises:
instructions for allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

10. The computer program product of claim 1, wherein said block comprises an end offset and a plurality of document postings.

11. The computer program product of claim 10, wherein each document posting in said plurality of document postings comprises (i) a document identifier uniquely identifying a document, and (ii) a number of occurrences of the search term in the document.

12. The computer program product of claim 10, wherein said instructions for modifying said block comprise instructions for adding one or more document postings to said plurality of document postings.

13. The computer program product of claim 10, wherein said instructions for modifying said block comprise instructions for removing one or more document postings from said plurality of document postings.

14. The computer program product of claim 11, wherein each document posting in said plurality of document postings further comprises, for each instance of said search term in the document, (i) a position of the instance of said search term in the document and, (ii) a context of the instance of said search term in the document.

15. The computer program product of claim 14, wherein the context of the instance of said search term is an identity of an HTML tag that encloses the instance of the search term in the document.

16. The computer program product of claim 1, the computer program mechanism further comprising instructions for maintaining a separate free list for each bucket in said plurality of buckets, wherein a free list for a bucket in said plurality of buckets comprises a list of each offset in said bucket that is available and wherein
when said block is added to said second bucket, said instructions for adding said block, in modified form, to said second bucket further comprise adding the offset, identified by said instructions for performing, to the free list for the first bucket and removing an offset to the block in the second bucket from the free list for the second bucket; and
when said block is added to said third bucket, said instructions for adding said block, in modified form, to said third bucket further comprise adding the offset, identified by said instructions for performing, to the free list for the first bucket and removing an offset to the block in the third bucket from the free list for the third bucket.

17. The computer program product of claim 1, wherein said search term is a word that appears in one or more documents identified by said block.

18. The computer program product of claim 1, wherein said search term is a name of a vertical collection stored in said block.

19. A computer program product for use in conjunction with a computer system, wherein the computer program product comprises a computer readable storage medium and a computer program mechanism embedded therein, the computer program mechanism comprising instructions for:
receiving a block for storage in a variable size data structure comprising a plurality of buckets, wherein each respective bucket in said plurality of buckets is characterized by a different predetermined data size and wherein each respective bucket in said plurality of buckets comprises a plurality of blocks, and wherein each block in the plurality of blocks in a respective bucket in said plurality of buckets is allocated the data size in the respective bucket that characterizes the respective bucket;
determining a size of said block, wherein said size of said block determines an identity of a first bucket in said plurality of buckets that will be used to store said block;
retrieving an offset from a free list that uniquely corresponds to said first bucket, thereby removing said offset from said free list; and
storing said block in said first bucket at said offset retrieved from the free list.

20. The computer program product of claim 19, the computer program mechanism further comprising:
instructions for adding a data entry for said block to a lookup table, said data entry comprising said offset and an identifier for said first bucket.

21. The computer program product of claim 20, wherein said block represents a search term and said instructions for adding said data entry for said block to said lookup table comprises hashing said search term.

22. The computer program product of claim 20, wherein said block represents a vertical collection and said instructions for adding said data entry for said block to said lookup table comprises hashing a name of the vertical collection.

23. The computer program product of claim 19, wherein the computer program mechanism comprises:
instructions for allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

24. The computer program product of claim 19, wherein said block comprises an end offset and a plurality of document postings.

25. The computer program product of claim 24, wherein each document posting in said plurality of document postings comprises (i) a document identifier uniquely identifying a document; and (ii) a number of occurrences of a search term in the document.

26. The computer program product of claim 25, wherein each document posting in said plurality of document postings further comprises, for each instance of said search term in the document, (i) a position of the instance of said search term in the document; and (ii) a context of the instance of said search term in the document.

27. The computer program product of claim 26, wherein the context of the instance of said search term is an identity of an HTML tag that encloses the instance of the search term in the document.

28. A computer comprising:
a central processing unit;
a memory coupled to the central processing unit, the memory storing instructions for:
receiving a query for a search term;
performing a lookup for said search term, wherein said lookup identifies a first bucket in a data structure comprising a plurality of buckets, the lookup further identifying an offset into said first bucket, wherein each respective bucket in said plurality of buckets is characterized by a different predetermined data size and wherein each respective bucket in said plurality of buckets comprises a plurality of blocks, and wherein each block in the plurality of blocks in a respective bucket in said plurality of buckets is allocated the data size in the respective bucket that characterizes the respective bucket;
retrieving a block from the first bucket at the offset determined in said performing step;
modifying said block;
restoring said block, in modified form, to said first bucket at said offset when a size of said block, in modified form, does not exceed a maximum allowed block size for said first bucket and said block, in modified form, exceeds a minimum allowed block size for said first bucket;
adding said block, in modified form, to a second bucket in said plurality of buckets when the size of said block, in modified form, exceeds a maximum allowed block size for said first bucket; and
adding said block, in modified form, to a third bucket in said plurality of buckets when the size of said block, in modified form, is less than a minimum allowed block size for said first bucket.

29. The computer of claim 28, wherein
a first bucket in said plurality of buckets is characterized by a data size of 2⁴ bytes;
a second bucket in said plurality of buckets is characterized by a data size of 2⁵ bytes;
a third bucket in said plurality of buckets is characterized by a data size of 2⁶ bytes; and
a fourth bucket in said plurality of buckets is characterized by a data size of 2⁷ bytes.

30. The computer of claim 28, wherein a bucket in said plurality of buckets is characterized by a data size of 2²⁸ bytes.

31. The computer of claim 28, wherein a bucket in said plurality of buckets is characterized by a data size of 2²⁹ bytes.

32. The computer of claim 28, wherein a bucket in said plurality of buckets is characterized by a data size of 2³⁰ bytes.

33. The computer of claim 28, wherein said performing said lookup for said search term comprises:
hashing said search term to obtain a hash value; and
retrieving a data structure from a hash table using said hash value, wherein said data structure comprises said offset and a bucket identifier.

34. The computer of claim 33, wherein said data structure has a predetermined size and a predetermined first portion of said data structure is for said offset and a predetermined second portion of said data structure is for said bucket identifier.

35. The computer of claim 34, wherein predetermined size is 10 bits and 1000 bits.

36. The computer of claim 28, wherein the memory further comprises:
instructions for allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

37. The computer of claim 28, wherein said block comprises an end offset and a plurality of document postings.

38. The computer of claim 37, wherein each document posting in said plurality of document postings comprises (i) a document identifier uniquely identifying a document; and (ii) a number of occurrences of the search term in the document.

39. The computer of claim 37, wherein said instructions for modifying said block comprise instructions for adding a document posting to said plurality of document postings.

40. The computer of claim 37, wherein said instructions for modifying said block comprise instructions for removing a document posting from said plurality of document postings.

41. The computer of claim 38, wherein each document posting in said plurality of document postings further comprises, for each instance of said search term in the document, (i) a position of the instance of said search term in the document; and (ii) a context of the instance of said search term in the document.

42. The computer of claim 41, wherein the context of the instance of said search term is an identity of an HTML tag that encloses the instance of the search term in the document.

43. The computer of claim 28, the memory further comprising instructions for maintaining a separate free list for each bucket in said plurality of buckets, wherein a free list for a bucket in said plurality of buckets comprises a list of each offset in said bucket that is available for receiving a new block and wherein
when said block is added to said second bucket, said instructions for adding said block, in modified form, to said second bucket further comprise adding the offset, identified by said instructions for performing, to the free list for the first bucket and removing an offset to the block in the second bucket from the free list for the second bucket; and
when said block is added to said third bucket, said instructions for adding said block, in modified form, to said third bucket further comprise adding the offset, identified by said instructions for performing, to the free list for the first bucket and removing an offset to the block in the third bucket from the free list for the third bucket.

44. The computer of claim 28, wherein said search term is a word that appears in one or more documents identified by said block.

45. The computer of claim 28, wherein said search term is a name of a vertical collection stored in said block.

46. A computer comprising:
a central processing unit;
a memory coupled to the central processing unit, the memory storing instructions for:
receiving a block for storage in a variable size data structure comprising a plurality of buckets, wherein each respective bucket in said plurality of buckets is characterized by a different predetermined data size and wherein each respective bucket in said plurality of buckets comprises a plurality of blocks, and wherein each block in the plurality of blocks in a respective bucket in said plurality of buckets is allocated the data size in the respective bucket that characterizes the respective bucket;
determining a size of said block, wherein said size of said block determines an identity of a first bucket in said plurality of buckets that will be used to store said block;
retrieving an offset from a free list that uniquely corresponds to said first bucket, thereby removing said offset from said free list; and
storing said block in said first bucket at said offset.

47. The computer of claim 46, the memory further comprising:
instructions for adding a data entry for said block to a lookup table, said data entry comprising said offset and an identifier for said first bucket.

48. The computer of claim 47, wherein said block represents a search term and said instructions for adding said data entry for said block to said lookup table comprises hashing said search term.

49. The computer of claim 47, wherein said block represents a vertical collection and said instructions for adding said data entry for said block to said lookup table comprises hashing a name of the vertical collection.

50. The computer of claim 46, wherein the memory further comprises:
instructions for allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

51. The computer of claim 46, wherein said block comprises an end offset and a plurality of document postings.

52. The computer of claim 51, wherein each document posting in said plurality of document postings comprises (i) a document identifier uniquely identifying a document; and (ii) a number of occurrences of a search term in the document.

53. The computer of claim 52, wherein each document posting in said plurality of document postings further comprises, for each instance of said search term in the document, (i) a position of the instance of said search term in the document and (ii) a context of the instance of said search term in the document.

54. The computer of claim 53, wherein the context of the instance of said search term is an identity of an HTML tag that encloses the instance of the search term in the document.

55. A method comprising:
receiving a query for a search term;
performing a lookup for said search term, wherein said lookup identifies a first bucket in a data structure comprising a plurality of buckets, the lookup further identifying an offset into said first bucket, wherein each respective bucket in said plurality of buckets is characterized by a different predetermined data size and wherein each respective bucket in said plurality of buckets comprises a plurality of blocks, and wherein each block in the plurality of blocks in a respective bucket in said plurality of buckets is allocated the data size in the respective bucket that characterizes the respective bucket;
retrieving a block from the first bucket at the offset determined in said performing step;
modifying said block;
restoring said block, in modified form, to said first bucket at said offset when a size of said block does not exceed a maximum allowed block size for said first bucket and exceeds a minimum allowed block size for said first bucket;
adding said block, in modified form, to a second bucket in said plurality of buckets when the size of said block, in modified form, exceeds a maximum allowed block size for said first bucket; and
adding said block, in modified form, to a third bucket in said plurality of buckets when the size of said block, in modified form, is less than a minimum allowed block size for said first bucket.

56. The method of claim 55, wherein said performing said lookup for said search term comprises:
hashing said search term to obtain a hash value; and
retrieving a data structure from a hash table using said hash value, wherein said data structure comprises said offset and a bucket identifier.

57. The method of claim 55, the method further comprising:
allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

58. The method of claim 55, the method further comprising maintaining a separate free list for each bucket in said plurality of buckets, wherein a free list for a bucket in said plurality of buckets comprises a list of each offset in said bucket that is available for receiving a new block and wherein
when said block is added to said second bucket, said instructions for adding said block, in modified form, to said second bucket further comprise adding the offset, identified by said instructions for performing, to the free list for the first bucket and removing an offset to the block in the second bucket from the free list for the second bucket; and
when said block is added to said third bucket, said instructions for adding said block, in modified form, to said third bucket further comprise adding the offset, identified by said instructions for performing, to the free list for the first bucket and removing an offset to the block in the third bucket from a free list for the third bucket.

59. A method comprising:
receiving a block for storage in a variable size data structure comprising a plurality of buckets, wherein each respective bucket in said plurality of buckets is characterized by a different predetermined data size and wherein each respective bucket in said plurality of buckets comprises a plurality of blocks, and wherein each block in the plurality of blocks in a respective bucket in said plurality of buckets is allocated the data size in the respective bucket that characterizes the respective bucket;
determining a size of said block, wherein said size of said block determines an identity of a first bucket in said plurality of buckets that will be used to store said block;
retrieving an offset from a free list that uniquely corresponds to said first bucket, thereby removing said offset from said free list; and
storing said block in said first bucket at said offset retrieved from the free list.

60. The method of claim 59, the method further comprising:
adding a data entry for said block to a lookup table, said data entry comprising said offset and an identifier for said first bucket.

61. The method of claim 59, wherein said block is associated with a search term and said adding said data entry for said block to said lookup table comprises hashing said search term.

62. The method of claim 59, wherein said block is associated with a vertical collection and said adding said data entry for said block to said lookup table comprises hashing a name of the vertical collection.

63. The method of claim 59, the method further comprising:
allocating a portion of each bucket in said plurality of buckets to storage in RAM memory and a portion of each bucket in said plurality of buckets to storage in magnetic memory; wherein a block in a bucket in said plurality of buckets is allocated to the portion of the bucket stored in magnetic memory on a least used basis.

64. The computer program product of claim 20, wherein said block represents an anchor collection and said instructions for adding said data entry for said block to said lookup table comprises hashing a name of the anchor collection.
